(19) United States
(12) Patent Application Publication
(10) Pub. No.: US 2026/0164198 A1
(43) Pub. Date: Jun. 11, 2026

(54) APPARATUS FOR HEADPHONE FUNCTIONALITY TESTING AND METHOD FOR THE SAME

(71) Applicant: Communications Test Design, Inc., West Chester, PA (US)

(72) Inventors: Milind PRAJAPATI, West Chester, PA (US); Gordon LO, West Chester, PA (US); Krutharth PATEL, West Chester, PA (US); Emily EVERLOF, West Chester, PA (US)

(73) Assignee: Communications Test Design, Inc., West Chester, PA (US)

(21) Appl. No.: 18/971,784

(22) Filed: Dec. 6, 2024

(51) Int. Cl. H04R 29/00; H04R 1/04; H04R 1/10

(52) U.S. Cl. CPC H04R 29/001; H04R 1/04; H04R 1/1083; H04R 29/008; H04R 2420/07

(57) ABSTRACT

An apparatus and method for testing headphone functionality is shown and described. The apparatus for testing headphone functionality includes a cabinet having a first compartment located therein. At least one speaker is located within the first compartment. The at least one speaker is operably coupled to a computer. At least one microphone is located within the first compartment. The at least one microphone is operably coupled to the computer. A wireless transceiver is operably coupled to the computer. A scanner is operably coupled to the computer and is removably secured to the cabinet.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

Headphones may be returned or traded in for any number of reasons. In some instances, these headphones may not be used at all and simply are not comfortable for a user. In other instances, the headphones may be lightly used and traded in for a new pair. Often times these devices can be resold to prevent a company from taking a loss on the return, or allow for a profit on a trade in. Testing is currently done via a human listening to the headphones or performing various actions. This can lead to errors in pass or fail rates due to differences in hearing ability of the tester.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides an apparatus for headphone functionality testing and method for the same wherein the same can be utilized for providing convenience for the user when preparing to resell or refurbish a pair of headphones. The apparatus for testing headphone functionality includes a cabinet having a first compartment located therein. At least one speaker is located within the first compartment. The at least one speaker is operably coupled to a computer. At least one microphone is located within the first compartment. The at least one microphone is operably coupled to the computer. A wireless transceiver is operably coupled to the computer. A scanner is operably coupled to the computer and is removably secured to the cabinet.

Another object of the apparatus for testing headphone functionality is to have at least one barcode is secured to the cabinet.

Another object of the apparatus for testing headphone functionality is to have the at least one barcode correspond to a test input when scanned.

Another object of the apparatus for testing headphone functionality is to have the first compartment have an interior lining of noise cancelling materials.

Another object of the apparatus for testing headphone functionality is to have a platform located within the first compartment.

Another object of the apparatus for testing headphone functionality is to have the at least one microphone be housed within a model ear.

Another object of the apparatus for testing headphone functionality is to have a charging device located on the platform.

Another object of the apparatus for testing headphone functionality is to have a display operably coupled with the computer.

Another object of the apparatus for testing headphone functionality is to have the display show a GUI.

Another object of the apparatus for testing headphone functionality is to have the GUI display headphone test results.

Another object of the apparatus for testing headphone functionality is to have the wireless transceiver is configured to support BlueTooth.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows an example of a first type of headphones.

FIG. 2B shows an example of a second type of headphones.

FIG. 3 shows a perspective view of an embodiment of the front of the apparatus for headphone functionality testing.

FIG. 4 shows a perspective view of an embodiment of the interior of the interior of a cabinet for the apparatus for headphone functionality testing.

FIG. 5 shows a close-up view of an embodiment of a screen for the apparatus for headphone functionality testing

FIG. 6 shows a flow chart of an embodiment of a method for headphone functionality testing.

### DETAILED DESCRIPTION OF THE INVENTION

For the purposes of presenting a brief and clear description of the present invention, a preferred embodiment will be discussed as used for the apparatus for headphone functionality testing and method for the same. The figures are intended for representative purposes only and should not be considered to be limiting in any respect.

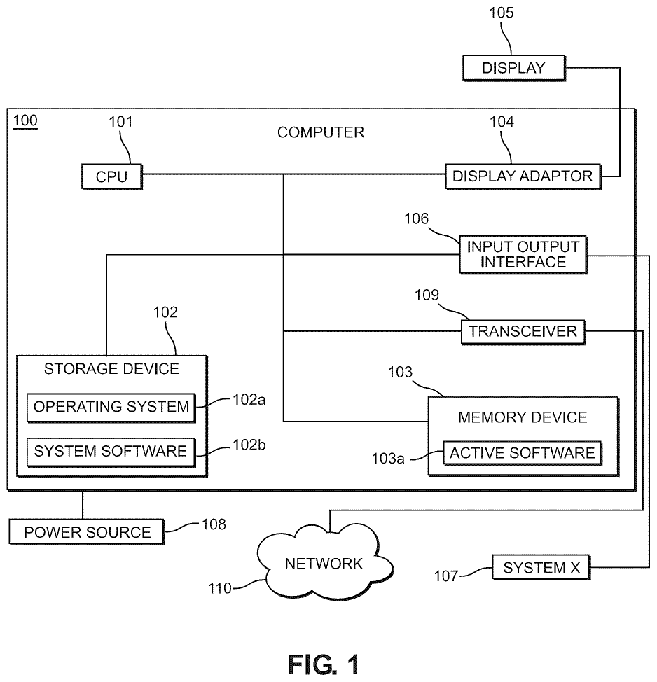

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

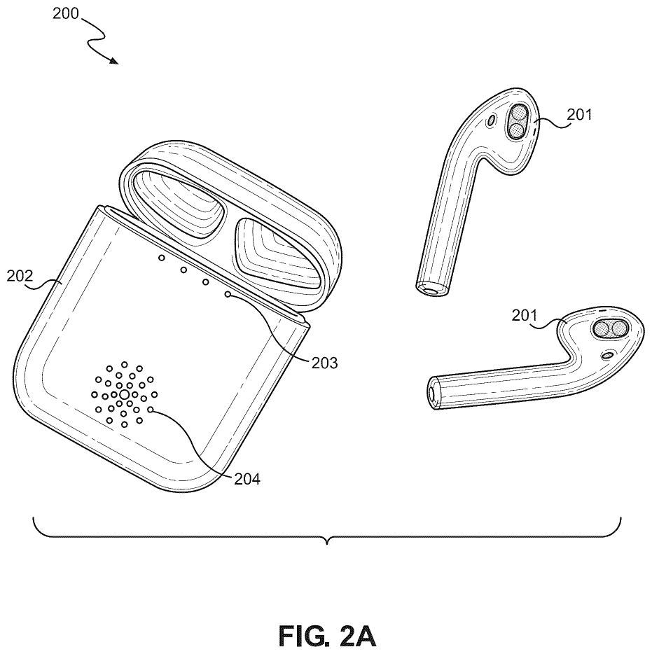

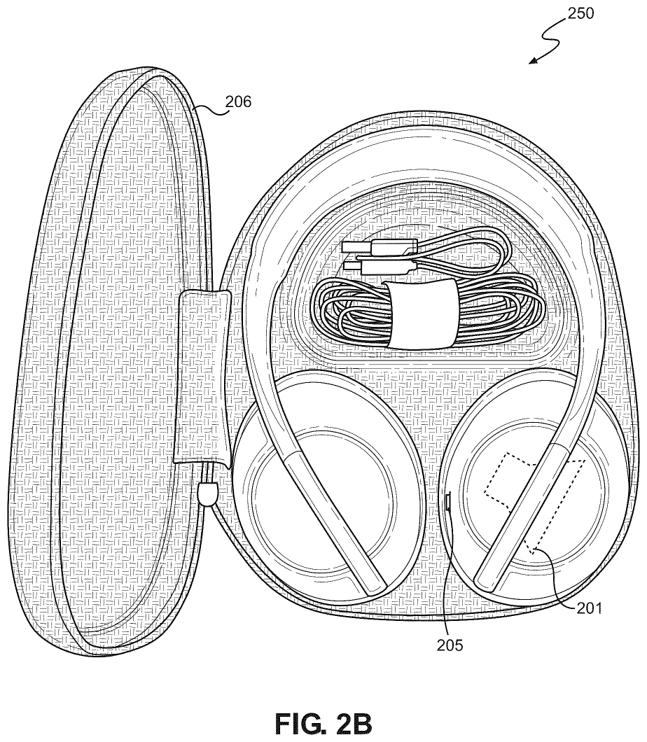

Referring now to FIG. 2A and FIG. 2B, there is shown two examples of different types of headphones. There are many different types and brands of headphones. However, many of these can be sorted into two categories; ear buds 200 and over ear headphones 250. Each category may be corded or wireless, the main difference, aside from the cord, is the battery and the connection type. Otherwise, each category generally has similar features and function.

Ear buds 200 will fit in the ear and may have supports to secure each ear bud therein. Each ear bud 200 will include a speaker 201, and may include a microphone. If the ear buds 200 are wireless they will have a wireless transceiver located therein. In many embodiments headphones have controls located on the headphones, such as pause/play, volume up and volume down and skip or rewind.

The wireless ear buds 200 will usually be accompanied by carrying case 202. In many instances the carrying case 202 will include a battery which is configured to charge the ear buds. In some instances, the carrying case 202 may include other features such as lights 203 or a speaker 204.

The second type of headphones, over ear headphones 250, include many of the same features as the ear buds 200. For example, over ear headphones 250 include a speaker 201, and may include a microphone. In many embodiments headphones have controls located on the headphones, such as pause/play, volume up and volume down and skip or rewind. If the over ear headphones 250 are wireless they will have a wireless transceiver located therein. Further wireless over ear headphones 250 will have a button 205 located therein in order to power the headphones. In some instances the over ear headphones 250 may include a carrying case 206, however, seldomly does the carrying case include any special features.

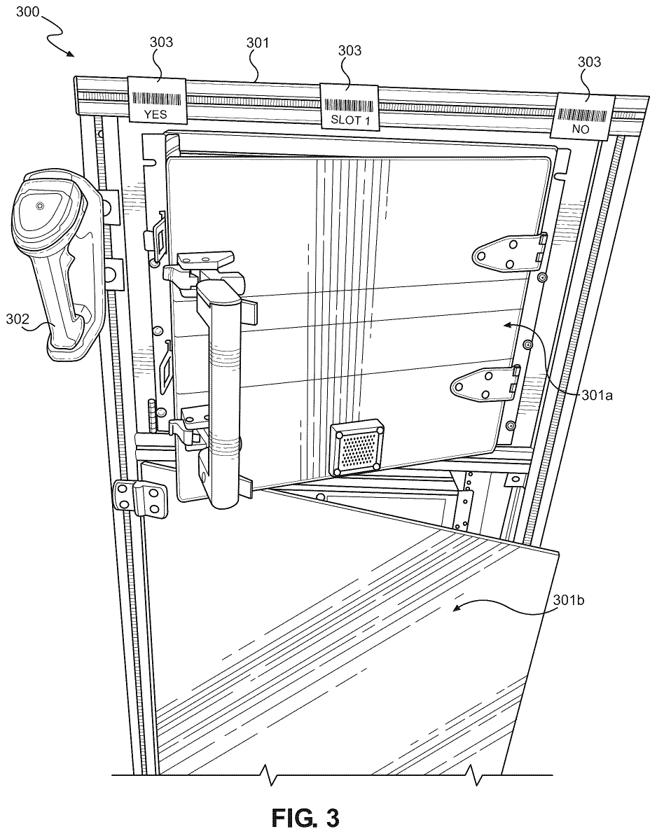

Referring now to FIG. 3, there is shown a perspective view of an embodiment of the front of the apparatus for headphone functionality testing. The apparatus for headphone functionality testing 300 is comprised of cabinet 301. In the shown embodiment the cabinet includes a top compartment 301a and a bottom compartment 301b. In other embodiments more compartments can be included without departing from the spirit of the invention. In many instances additional compartments will be included as a duplication of parts in order to expand testing capacity.

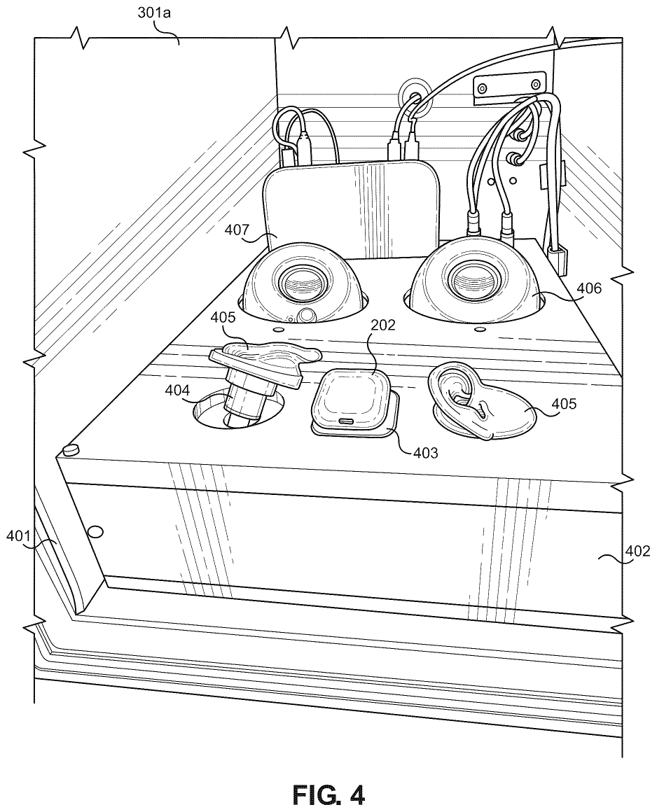

In one embodiment the bottom compartment 301b includes at least one computer. Multiple computers may be stored in the bottom compartment 301b. In different embodiments the bottom compartment 301b is proportion to have a different width than the top compartment(s) 301a. This could allow for multiple top compartments 301a and only one bottom compartment 301b. The top compartment 301a will house various testing components as described in the description of FIG. 4.

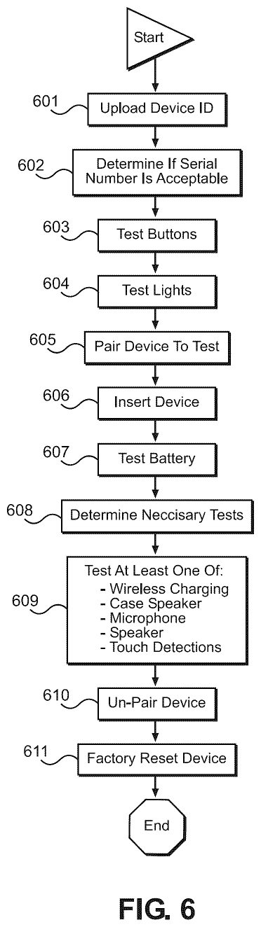

In some embodiments the apparatus for headphone functionality testing 300 includes a barcode scanner 302. The barcode scanner 302 can be used to scan a barcode of the headphones to be tested as will be described in the description of FIG. 6. In one embodiment barcodes 303 are associated with answers necessary for various questions which are part of the testing method. In this embodiment the barcodes 303 are secured to the cabinet 301 of the tester.

Referring now to FIG. 4, there is shown a perspective view of an embodiment of the interior of the interior of a cabinet for the apparatus for headphone functionality testing. The interior of the top compartment 301a has an interior volume which houses testing components. In one embodiment the perimeter includes noise cancelling materials 401. The noise cancelling materials 401 help to ensure that when multiple sets of headphones are tested the results are not skewed by noise contamination.

In one embodiment there is a platform 402 placed within the top compartment 301a. The platform 402 allows for various components to be placed therein. In the shown embodiment there is a charging device 403 placed in the platform 402. This will allow for the carrying case 202 of a pair of earbuds to be tested along with the headphones.

In one embodiment there is a pair of microphones 404 located within the platform 401. In the shown embodiment each microphone is secured to a model ear 405. The model ear 405 allows for an ear bud to be placed therein. During testing the microphones 404 can receive audio from each headphone. In one embodiment the microphones 404 are placed within a model head or other device which would allow for the testing of an over ear headphone.

The testing components also may include at least one speaker 406. The at least one speaker 406 can be used to test the microphone of the headphones. In order to allow for proper testing of wireless headphones a wireless transceiver 407 is included. The wireless transceiver 407 will connect to, send signals to, and receive signals from, the headphones to be tested. The wireless transceiver 407 is operably coupled to the at least one computer.

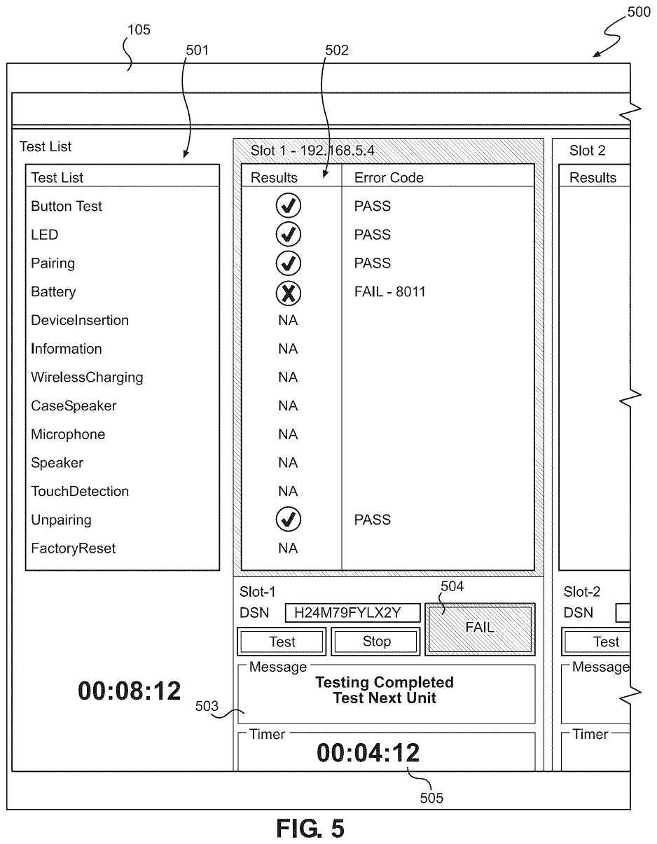

Referring now to FIG. 5, there is shown a close-up view of an embodiment of a screen for the apparatus for headphone functionality testing. A display 105 is included as part of the headphone tester. In one embodiment the display 105 doubles as a human machine interface, for example a touchscreen. The display 105 supports the display of a graphical user interface (GUI) 500. The GUI 500 is capable of displaying tests to be performed 501, the test results 502, and instructions for performing testing steps 503.

In one embodiment the GUI 500 displays a final pass or fail grade 504 for the headphones. This will help to ensure that headphones are properly categorized. In addition, the time for testing 505 may be displayed. In some embodiments a failure may be recorded if a test takes more time than a threshold allowance.

Referring now to FIG. 6, there is shown a flow chart of an embodiment of a method for headphone functionality testing. The testing method begins by uploading the headphone ID to the testing system 601. The headphone ID may be a serial number, or specialized device id which may be specific to the testing company or system. The device ID is in some way associated with the device's serial number. In some embodiments there may be multiple serial numbers associated with a set of earbuds and the carry case. After the headphone ID is uploaded 601 the serial number(s) is checked against the record of the headphones to ensure they are acceptable 602. In one embodiment this means that the headphones have the correct serial number. In one embodiment this ensures that the headphones are not registered as stolen.

After the determination is made of the headphones being acceptable 602 the testing can begin, so long as they are accepted. In one embodiment the first step of testing is to test the buttons of the headphone 603. This can ensure that the various buttons of the headphones such as the play/pause button, the forward and reverse buttons, and the volume buttons function properly. Next the devices lights may be tested 604. Various lights my be included with headphones to demonstrate mode or charge amount. Next the headphones are paired with the at least one computer 605. Any of these steps may be skipped without departing from the method as some of the steps may not be required due to the functionality of the headphones.

After the previous steps are completed the headphones are inserted into the compartment 606. After the headphones are placed in the compartment the battery can be tested 607. In one embodiment this means placing the headphone case on a charging pad. In another embodiment this could mean plugging a charger into the headphones. In different embodiments different headphones will require different methods to test battery functionality. One of ordinary skill in the art will understand how to determine best test the battery of a set of headphones, depending on the headphones.

The necessary tests to be complete are then determined 608. In one embodiment the tests to be completed are determined when the headphone ID is uploaded. The system then tests at least one of: wireless charging, case speaker, headphone microphone, headphone speakers, touch detections 609. After these tests are completed the device, where applicable is unpaired from the tester 610. The headphones are then factory reset and placed in a like new status 611. The system will then record the results and associated the results with the headphone ID and the method ends.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

1) An apparatus for testing headphone functionality, the apparatus comprising:
a cabinet having a first compartment located therein;
at least one speaker located within the first compartment, wherein the at least one speaker is operably coupled to a computer;
at least one microphone located within the first compartment, wherein the at least one microphone is operably coupled to the computer;
a wireless transceiver operably coupled to the computer;
a scanner operably coupled to the computer is removably secured to the cabinet.

2) The apparatus for testing headphone functionality of claim 1 wherein at least one barcode is secured to the cabinet.

3) The apparatus for testing headphone functionality of claim 2 wherein the at least one barcode corresponds to a test input when scanned.

4) The apparatus for testing headphone functionality of claim 1 wherein the first compartment has an interior lining of noise cancelling materials.

5) The apparatus for testing headphone functionality of claim 1 further comprising a platform located within the first compartment.

6) The apparatus for testing headphone functionality of claim 1, wherein the at least one microphone is housed within a model ear.

7) The apparatus for testing headphone functionality of claim 5 wherein a charging device is located on the platform.

8) The apparatus for testing headphone functionality of claim 1, further comprising a display operably coupled with the computer.

9) The apparatus for testing headphone functionality of claim 8 wherein the display shows a GUI.

10. The apparatus for testing headphone functionality of claim 9, wherein the GUI displays headphone test results.

11. The apparatus for testing headphone functionality of claim 1, wherein the wireless transceiver is configured to support BlueTooth.
